(19) United States
(12) Patent Application Publication
(10) Pub. No.: US 2006/0115159 A1
(43) Pub. Date: Jun. 1, 2006

(54) Boundary detection for images using coocurrence matrices

(76) Inventor: Astrit Rexhepi, Unmik (YU)

Correspondence Address: GOTTLIEB RACKMAN & REISMAN PC, 270 MADISON AVENUE, 8TH FLOOR, NEW YORK, NY, 100160601, US

(21) Appl. No.: 10/999,476

(22) Filed: Nov. 30, 2004

(51) Int. Cl. G06K 9/48; G06K 9/40

(52) U.S. Cl. 382/199; 382/260

(57) ABSTRACT

This application pertains to methods of extracting region boundaries from the frames of an image sequence by combining information from spatial or temporal cooccurrence matrices of the frames. Filtering and feedback techniques are used for reducing spurious noise.

### RELATED APPLICATIONS

none.

### BACKGROUND OF THE INVENTION

A. Field of Invention

This invention pertains to a method and apparatus for detecting and recognizing images using matrix processing techniques, including cooccurrence matrices.

B. Description of the Prior Art

Cooccurrence Matrices and Their Uses

Cooccurrence matrices, originally called gray-tone spatial dependency matrices, were introduced by Haralick et al., (R. M. Haralick, R. Shanmugam, and I. Dinstein, Textural Features for Image Classification, IEEE Trans. on Systems, Man, and Cybernetics, Vol. 3,1973, pp. 610-621). who used them to define textural properties of images.

Let I be an image whose pixel gray levels are in the range 0, . . . , 255. Let S =(u, v) be an integer-valued displacement vector; S species the relative position of the pixels at coordinates (x, y) and (x+u, y+v). A spatial cooccurrence matrix Ms of I is a 256×256 matrix whose (i, j) element is the number of pairs of pixels of I in relative position S such that the first pixel has gray level i and the second one has gray level j. Any S, or set of s, S's, can be used to define a spatial cooccurrence matrix. In this application it is assumed that S is a set of unit horizontal or vertical displacements, so that Ms involves counts of pairs of neighboring pixels.

In addition to their original use in defining textural properties, cooccurrence matrices have been used for image segmentation. Ahuja and Rosenfeld (N. Ahuja and A. Rosenfeld, A Note on the Use of Second-order Gray-level Statistics for Threshold Selection, IEEE Trans. on Systems, Man, and Cybernetics, Vol. 8, 1978, pp. 895-898.) observed that pairs of pixels in the interiors of smooth regions in I contribute to elements of Mo near its main diagonal; thus in a histogram of the gray levels of the pixels that belong to such pairs, the peaks associated with the regions will be preserved, but the valleys associated with the boundaries between the regions will be suppressed, so that it becomes easier to select thresholds that separate the peaks and thus segment the image into the regions. In an article (J. F. Haddon and J. F. Boyce, Image Segmentation by Unifying Region and Boundary Information, IEEE Trans. on Pattern Analysis and Machine Intelligence, Vol. 12, 1990, pp. 929-948.), Haddon and Boyce observed that homogeneous regions in I give rise to peaks (clusters of high-valued elements) near the main diagonal of Mb, while boundaries between pairs of adjacent regions give rise to smaller peaks at off-diagonal locations; thus selecting the pixels that contribute to on-diagonal and off-diagonal peaks provides a segmentation of I into homogeneous regions and boundaries.

Pairs of pixels in the same spatial position that have a given temporal separation in a sequence of images can be used to define temporal cooccurrence matrices. Let I and J be images acquired at times t and t+dt; thus dt is the temporal displacement between I and J. A temporal cooccurrence matrix Mdt is a 256×256 matrix whose (i, j) element is the number of pairs of pixels in corresponding positions in I and J such that the first pixel has gray level i and the second one has gray level j.

Boyce et al. (J. F. Boyce, S. R. Protheroe, and J. F. Haddon, A Relaxation Computation of Optic Flow from Spatial and Temporal Cooccurrence Matrices, International Conference on Pattern Recognition, Vol. 3,1992, pp. 594-597.) introduced temporal cooccurrence matrices and used them in conjunction with spatial cooccurrence matrices to make initial estimates of the optical flow in an image sequence. They demonstrated that an initial probability of a pixel being in the interior or on the boundary of a region that has smooth optical flow in a given direction in a pair of images could be derived from the positions of the peaks in a spatial cooccurrence matrix of one of the images for a displacement in the given direction, and in the temporal cooccurrence matrix of the pair of images. Borghys et al. (D. Borghys, P. Verlinde, C. Perneel, and M. Acheroy, Long-range Target Detection in a Cluttered Environment Using Multi-sensor Image Sequences, Proc. SPIE, vol. 3068, 1997, pp. 569-578.) used temporal cooccurrence matrices to detect sensor motion in a moving target detection system by comparing the spatial cooccurrence matrix of one of the images with the temporal cooccurrence matrix of the pair of images.

### SUMMARY OF THE INVENTION

Moving Boundaries detection is a crucial step in computer vision that determines success or failure of the whole system. Thus, if the system cannot detect clear boundaries then all other steps such as localization, recognition or tracking will fail. Methods used so far in computer vision for moving boundaries detection were Background Subtraction and image Subtraction. First one (Background Subtraction) is based on developing some statistics of the background before a moving object gets in. It is obvious that this method can not be used for tracking when it is required from camera to follow moving object. Second one (Image Subtraction) uses direct image subtraction. It is used widely in computer vision for moving object detection and tracking. The disadvantage of this method is that it requires a threshold to be set by hand. The threshold T (threshold T is a value that is used to decide what is the boundary and what is the noise, differences greater than T are assumed to be boundaries, and differences les than T are assumed to be noise) that we set by hand is not constant for all cases but it varies significantly in various applications due to various factors. An example of this is shown in FIG. 8 where in two cases we needed to set two different thresholds in order to obtain clean moving boundaries. Another disadvantage of this method is that when in two consecutive frames there are lightness disturbances than it fails in finding boundaries. In this paper we presented an integrated space-and-time system for moving boundary detection and its extension for static boundaries. This system is full-automatic (no human intervention is need) which has the following properties: This system has the following important properties:
a. Does not make use of any threshold.
b. Almost completely removes noise.
c. Very stable in case of lightness disturbances.
d. The width of filter F can be used as a qualitative measure of speed of the moving object.
e. In the same framework we can extract both moving and static boundaries.
f. The complete system can be developed using only Boolean algebra.
g. It is fast and very easy to realize even in hardware.

### BRIEF DESCRIPTION OF THE DRAWINGS

FIGS. 1a and 1b show two synthetic images (images I and J); FIGS. 1c and 1d show the temporal cooccurrence matrices. Corresponding to images I and J;

FIGS. 1e and 1f show the mutual suppression between the cooccurences of FIGS. 1c and 1d.

FIG. 2a-f show respectively, a Filter F, the matrix M and filter F, a smoothed M+F. setting to one all the nonzero elements of the smoothed M+F yielding F, the operation M+F=M′. (f) and the operation N/M′

FIG. 3a shows the result obtained by only temporal cooccurrence matrices suppression;

FIG. 3b shows the result after filtering with F;

FIG. 3c the result after applying feedback-system;

FIG. 3d the result after noise removal;

FIG. 4:(a) and (b) two successive frames of an image sequence showing a moving man. (c) and (d) moving and static boundary detection using our system;

FIG. 5:(a) and (b) show two successive frames of an image sequence showing a moving speaker-woman.

FIG. 5 (c) and (d) show moving and static boundary detection using our system;

FIGS. 6a and 6b show two successive frames of an image sequence showing a moving woman and a child;

FIGS. 6c and 6d moving and static boundary detection using our system;

FIGS. 7a and 7b show two successive frames of an image sequence showing a man waiving his hands and arms.

FIGS. 7c and 7d show moving and static boundary detection using our system.

FIGS. 8a Image Subtraction of FIGS. 4(a and b), 8b show moving boundaries after applying a threshold T=40; 8c show an Image Subtraction of FIGS. 5(a and b); and FIG. 8d show Moving boundaries after applying a threshold T=7.

FIG. 9 shows a simplified diagram of the process for manipulating images in accordance with this invention.

FIG. 10 shows a block diagram of an apparatus for performing the process of FIG. 9.

### DETAILED DESCRIPTION OF THE INVENTION

The Structure of Cooccurrence Matrices

Methods of using temporal cooccurrence matrices to extract moving region boundaries from the images of a sequence are described below. In this section I will describe the peak structures that should be present in spatial and temporal cooccurrence matrices. It is assumed that an image I is composed of regions in which (ignoring noise) the gray levels vary smoothly, and that if two regions are adjacent, they meet along a boundary at which the gray level changes significantly. It is well known that in a spatial cooccurrence matrix of I, each region (say having mean gray level g) should give rise to a peak centered on the main diagonal in approximate position (g, g); the sum of the element values in this cluster should be proportional to the area of the region. Similarly, each boundary between two adjacent regions (say having mean gray levels g and h) should give rise to a pair of o-diagonal peaks at approximate positions (g, h) and (h, g), and with value sum proportional to the length of the border.

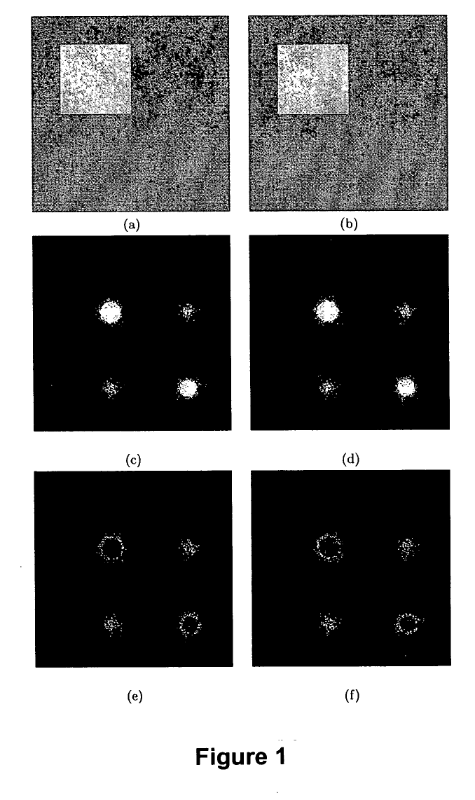

FIG. 1a is a test image I containing a solid square with gray level 200 on a background with gray level 100. This image is composed with noise having a normal distribution with mean value zero and variance of four. Let J be another image (FIG. 1b), similar to I but with the solid square having been moved from its original position up and to the right by one pixel, and having the same instance of noise generated by a random generator. We can treat I and J as consecutive frames of an image sequence acquired by a stationary camera. In this case, the frames show an object (solid square) moving against a stationary background at a rate of a few pixels per frame. In the temporal cooccurrence matrix of I and J (FIG. 1c), pairs of pixels that are in a moving region in both images will contribute to an on-diagonal peak. Similar, pairs of pixels that are in the background in both images will contribute also to another on-diagonal peak. Pairs of pixels that are covered up or uncovered by the motion will contribute to a pair of o-diagonal peaks.

Extracting Boundaries Using Cooccurrence Matrices

As discussed above, the motion of an object against a contrasting background between two frames of an image sequence gives rise to off-diagonal peaks in a temporal cooccurrence matrix of the two frames. Thus it should be possible in principle to extract moving boundaries from a pair of successive frames of an image sequence by detecting off-diagonal peaks in the temporal cooccurrence matrix of the two frames and identifying the pixels in either of the frames that contributed to those peaks.

Unfortunately, off-diagonal peaks are not always easy to detect in cooccurrence matrices. Since the images are noisy, all the elements near the diagonal of a cooccurrence matrix tend to have high values, and the presence of these values makes it hard to detect off-diagonal peaks in the matrix that lie close to the diagonal since these peaks tend to have lower values. If we knew the standard deviation of the image noise, we could estimate how far the high values which are due to noise extend away from the diagonal of the cooccurrence matrix, and we could then look for peaks in the matrix that are farther than this from the diagonal; but information about the image noise level is usually not available. In this section, a simple method is described for suppressing clusters of high-valued elements from a temporal cooccurrence matrix. As we will see, the suppressed matrix elements tend to lie near the diagonal of the matrix. Hence when the suppression process is applied to a temporal cooccurrence matrix the image pixels that contributed to the unsuppressed elements of the matrix tend to lie on the boundaries of moving regions.

Our method of suppressing clusters of high-valued elements from a coocurrence matrix takes advantage of two observations:

(1) The matrix elements in the vicinity of a high-valued cluster almost certainly have nonzero values, so that the nonzero values in and near the cluster are “solid. On the other hand, it is more likely that there are zero-valued elements in and near a cluster of low-valued elements, so that the nonzero values in and near such a cluster are “sparse”.

(2) As we saw in Section 2, the on-diagonal clusters in a cooccurrence matrix, when arise from regions in the image, can be expected to be symmetric around the main diagonal, and the off-diagonal clusters, which arise from motion, can be expected to occur in pairs whose means are symmetrically located around the main diagonal, since the noise in the image has zero mean. Hence if we have two cooccurrence matrices that are transposes of one another (see below), the clusters in these matrices should occur in the same approximate positions.

We can obtain temporal cooccurrence matrices that are transposes of one another by using reverse temporal displacements; i.e., if I and J are successive frames of an image sequence, we can use the temporal cooccurrence matrices of I and J (FIG. 1c) and of J and I (FIG. 1d). Evidently, FIG. 1c and FIG. 1d are transposes of each other.

Let M and N be two cooccurrence matrices that are transposes of one another. We suppress from M all elements that are nonzero in N (or vice versa). Elements of M that are in or near a “solid” cluster will almost certainly have nonzero values in N; hence these elements will almost certainly be suppressed from M. On the other hand, many of the elements of M that are in or near a “sparse” cluster will have zero values in N because the nonzero elements of these clusters in M and N are not in exactly symmetrical positions; hence many of these elements will not be eliminated by the suppression process.

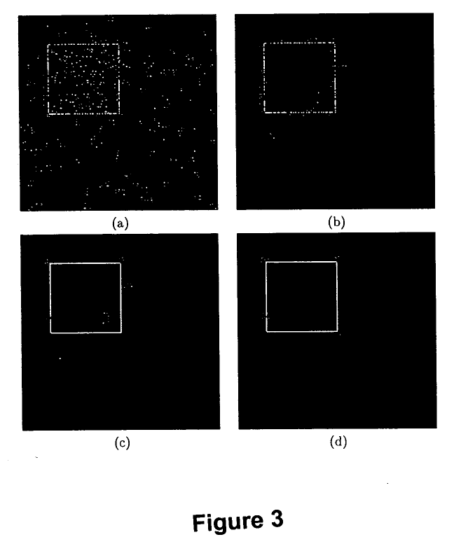

FIG. 1e shows the nonzero elements of FIG. 1c that are zero in FIG. 1d, and FIG. 1f shows the nonzero elements of FIG. 1d that are zero in FIG. 1c. We see that the “solid” parts of the matrix have been suppressed and the “sparse” parts have survived. FIG. 3a shows the pixels of FIG. 1a that contributed to the nonzero elements in FIG. 1e. Almost all of these pixels lie on region boundaries in FIG. 3a.

The Problem of Residuals

As we saw in the previous section, using temporal cooccurrence matrices suppression we achieved some important results. Namely, we are now able to detect moving boundaries and we don t need to set any threshold to do this, which is in contrast with existing methods. It is obvious that at this stage the results we just obtained contain some spurious noise pixels (FIG. 3a), but as we will show in this section, these spurious noise pixels we are able to eliminate successfully by filtering.

There are Two Reasons Why These Noise Pixels Appears in FIG. 3a:

a) The on-diagonal clusters in temporal cooccurrence matrices are results of regions (static and inside moving objects regions). Thus, a homogenous region R having an area (in pixels) A will yield an on-diagonal cluster in the temporal cooccurrence matrix whose shape is circular centered at (k, k) where k is the mean value of R, and a radius r that depends on noise variance (which is unknown) and the area of R. Usually, the noise has normal (multinomial) distribution or it can be approximated by normal distribution, thus, this cluster will be denser near (k, k) and the density decreases as we go away from (k, k). Places where the density of the cluster is low will survive suppression and we will call them residuals that have a ring shape as seen in FIG. 1 and FIG. 1. These residuals appear as noise pixels in FIG. 3a.

b) Small regions having a unique gray level will yield (approximately) on-diagonal sparse clusters in the temporal cooccurrence. Hence, when suppression is applied most of the elements of these clusters will survive. These elements appear as noise in FIG. 3a.

Designing the Filter to Suppress Residuals

One way of suppressing residuals is to develop a filter F as set forth below.

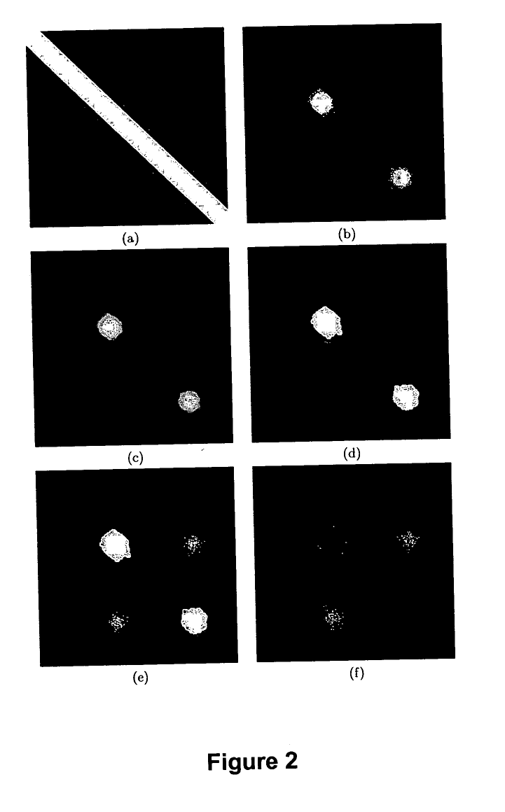

Let M and N be the temporal cooccurrence matrices of I and J as shown in FIG. 1c and FIG. 1d, and let S be one of suppressed cooccurrence matrices. A filter in the shape of a strip is placed along the main diagonal in M whose width is calculated using the following logic: Starting from zero, the width of the filter strip is increased until the number of nonzero elements of M that do not belong inside the filter F is equal (a place where the number of nonzero elements of M that do not belong inside F changes from being higher to smaller) the number of nonzero elements of S. (An interesting property of the width of F is that as the speed of moving object increases the width increases too. Thus, the width of F can be used as a qualitative measure of speed of the moving object.) After we find F (FIG. 2a), the next task is to use this filter and put along the main diagonal of N. Nonzero elements of N belonging inside the filter F (FIG. 2b) are smoothed using an averaging filter-like-a-disk (or we can perform dilation instead) with radius 3 for all cases (FIG. 2c). Let us set all the nonzero elements of this matrix to one and denote it by F′ as shown in FIG. 2d. Now, if we set to one all nonzero elements of this processed N (FIG. 2e) and suppress M from N (FIG. 2f) the ring-shaped residuals almost completely have disappeared. Let us denote this set as S′. The corresponding pixels of I that contributed to nonzero elements of S′ are shown in FIG. 3b, so let us denote it by B′. It is obvious that FIG. 3b is almost noiseless compared to FIG. 3a.

Moving Boundaries Enhancement and Noise Removal

In the previous section we were able to reduce the noise pixels using filter F. The results obtained are impressive, but still have to be done because moving boundaries appear to be broken and there are still some noise pixels to be cleaned. In this section we will be dealing with the above mentioned problems. Broken boundaries in FIG. 3b are the result of suppression process. As discussed in Section 3, the off-diagonal clusters of M and N are results of moving boundaries. These clusters are sparse but that doesn't mean that when the suppression process is applied they will completely survive, something is possible to be suppressed. These suppressed elements in turn results in missing parts of boundaries in FIG. 3b. To recover these missing parts of boundaries we will develop a feedback system that is based on the following assumption:

The density of nonzero elements in B′ in and around boundaries is higher so that around nonzero elements of B′ it is very likely to find elements (in the same spatial position) in I and J that contribute to nonzero elements of off-diagonal clusters of M F′ where/is a difference operator. On the other hand, the density of nonzero elements of B′ representing noise is very sparse, so that it is quite unlikely that around these points of B′ we will find (in the same spatial position) elements in I and J that contribute to any of nonzero elements in M F′. Thus, the suppressed elements of off-diagonal clusters of S′ can be recovered by searching in the neighborhood of nonzero elements of B′. The feedback system contains the following operations or steps:

a. Smooth B′ with an averaging filter of size 3×3 (or perform dilation).

b. Develop B″ by setting to one the positive elements of smoothed B′ (when performing dilation instead it is no need to use this step).

c. Create images I′=IB″ and J′=JB″.

d. Find their temporal cooccurrence matrix M′.

e. Find T=(M′/F′).

f. Find elements of I and J that contributed to nonzero elements of T, yielding an updated image B′

g. Repeat above steps until there is no change between consecutive B′ images.

Usually the last condition is satisfied after the third iteration, and the corresponding results (FIG. 3c) are very satisfactory. Finally, the remaining noise points we reduce by using an operator of size 5×5 and exclude positive elements (belonging to the center of the operator) of updated B′ if the total sum of positive elements inside the operator is less than 2. The result is shown in FIG. 3d. As shown in this Figure, the updated image B′ contains only the boundary of the moving object. It might have been thought that the same results could have been achieved by using only M F or by only using image difference and use the width of F as a threshold, but that is not possible in general because low contrast boundaries will vanished and many noise clusters will be left which are not possible to be cleaned in image domain because of their high density.

Detecting Static Boundaries

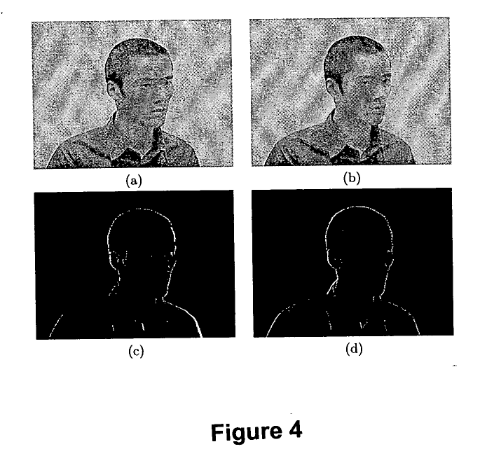

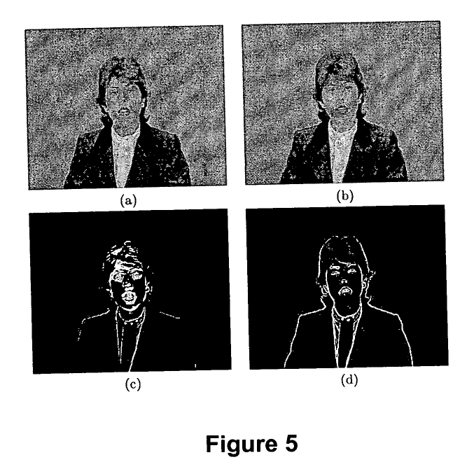

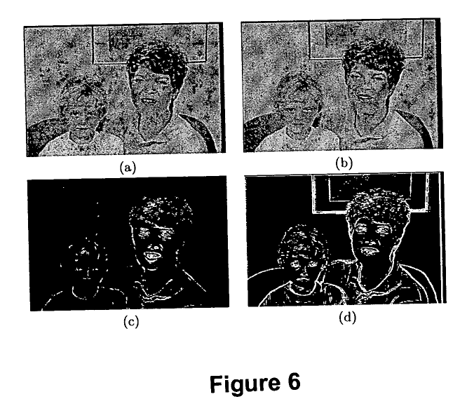

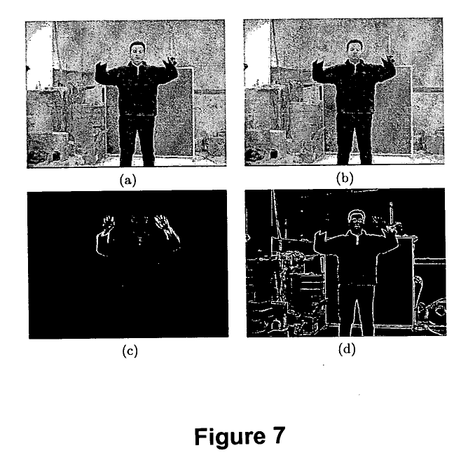

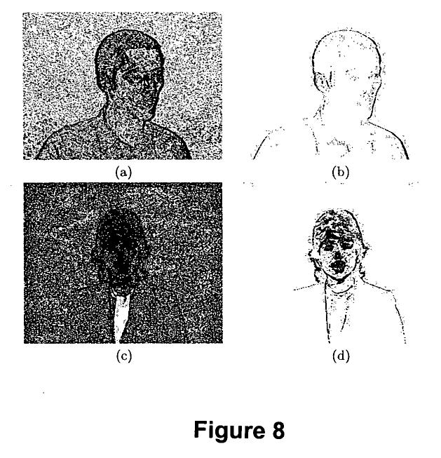

The method described above can be extended for static boundaries detection. To do this, it is assumed that the whole frame is moving in the amount of one pixel. Thus, we can slide one of the frames in the amount of one pixel and find the temporal cooccurrence matrices (in which ignoring border effects it is the same as spatial cooccurrence matrix), after we do this we filter on-diagonal elements using filter F′ (in a similar way we did for moving boundaries in the previous sections) and find the corresponding pixels in I and J that contributed to the nonzero elements of their filtered temporal cooccurrence matrix. Actual real images are shown in FIGS. 4-8 illustrating these principles.

The system we just presented will have wide application in military systems for automatic moving target detection, medical image diagnosis, animation, games, general surveillance systems, robotics, etc.

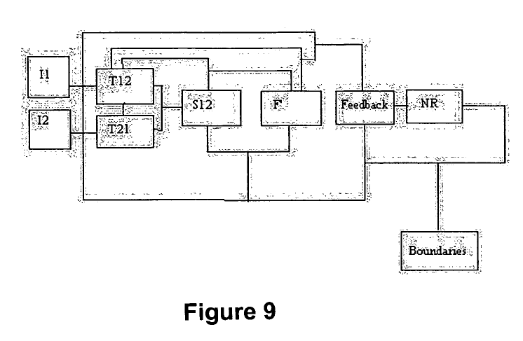

A flow chart is shown in FIG. 9. In this Figure, two images I1, I2 represent two consecutive frames acquired by a digital camera, or other similar means. The two images are converted into temporal cooccurrence matrices, T12 and T21 . . . S12 is a suppression matrix derived from T12 and T21. F′ is a filtering process derived using information from both S12 and T 12. Feedback is a process for moving boundaries enhancement, using information from I1, I2, T12, S12, F′. The feedback process repeats several times until there are no substantial changes in consecutive results. The result is then filtered by NR to remove noise. The boundaries of the processed and filtered data are then determined.

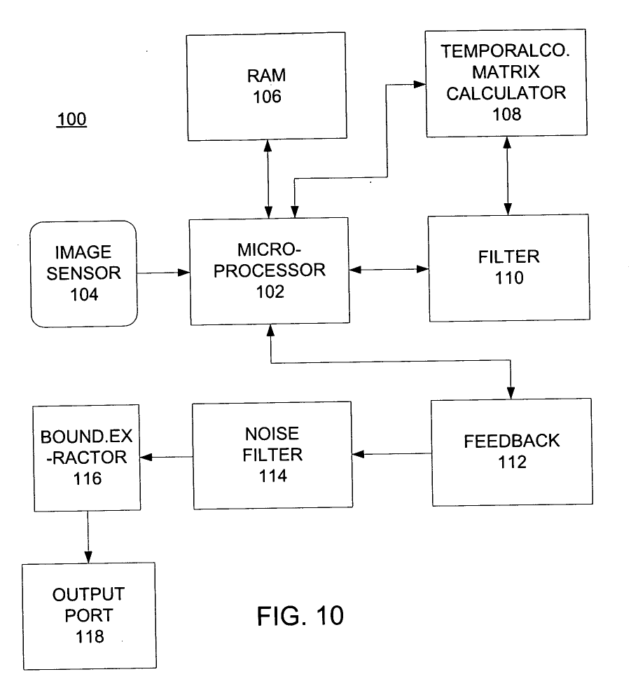

FIG. 10 shows an apparatus or device 100 used to implement the flow chart of FIG. 9. As shown in this Figure, the apparatus 100 includes a microprocessor 102, a RAM 106, a temporal cooccurrence matrix calculator 108, a filter 110, a feedback calculator 112, a noise filter 114, a boundary extractor 116 and an output port 118.

Images are obtained from an image sensor 104. This image sensor may be digital camera, a standard TV camera, a movie camera, a scanner, or other similar device that can be used to either to capture the image of a person or an object and convert it into a digital image, or receive any other types of images and convert them into digital data.

The microprocessor 102 is operated by software stored in RAM 106. The digital images received from the sensor 104, they are processed in accordance with the flow chart of FIG. 9 and the algorithm discussed above and illustrated in FIGS. 1-8. For particularly, the images are used to generate the temporal matrices by calculator 108. The filtering function F′ is performed by filter 110. The resulting matrices are then processed several times by the feedback processor 112 until two consecutive matrices are obtained. Noise is removed from the resultant matrix by the noise filter 114. The boundary extractor 116 identifies the boundaries of the noise filtered image and the result is displayed, stored for further processing, and/or sent on to other devices for further processing. All or most of the elements shown in FIG. 10 can be implemented by software in RAM 106; however they are shown as discrete elements for the sake of clarity.

Once the images are processed in the manner described, the result can be used for various purposes, especially in instances where image recognition is desirable, including automated object/face recognition, sorting of object, and so on.

Moreover, numerous modification can be made to this invention without departing from its scope as defined in the appended claims.

I claim:

1. An image processing method comprising:
receiving two input matrices corresponding to images;
generating a cooccurrence matrix from said input matrices; and
generating an output from said cooccurrence matrix.

2. The method of claim 1 further comprising filtering said cooccurrence matrix to generate a filtered matrix.

3. The method of claim 2 wherein said filtering includes defining a diagonal filter extending a first direction.

4. The method of claim 3 further comprising suppressing portions of the filtered matrix to generate a suppressed matrix.

5. The method of claim 4 wherein said suppressing includes eliminating portions distant from said diagonal.

6. The method of claim 4 further comprising operating on the suppressed matrix several times to generate processed matrices,

7. The method of claim 1 wherein said occurrence matrices are separated in the time domain.

8. The method of claim 1 wherein said occurrence matrices are separated spatially.

9. An apparatus for recognizing images comprising:
an image sensor receiving images of interest and generating corresponding two dimensional image matrices;
matrix generator means generating occurrence matrices corresponding to said image matrices; and
processor means operating on said occurrence matrices to obtain image boundaries.

10. The apparatus of claim 9 wherein said matrix generator generates occurrence matrices separated in the time domain.

11. The apparatus of claim 9 wherein said matrix generator generates spatially separated occurrence matrices.

12. The apparatus of claim 10 further comprising filtering means which compares said occurrence matrices to a two dimensional filter profile and separates image elements from said occurrence matrices based on said filter profile.

13. The apparatus of claim 12 wherein said occurrence matrices define an array and said filter profile extends along a diagonal across said array.

14. The apparatus of claim 13 wherein said filter is adapted to suppress off diagonal picture elements.

15. The apparatus of claim 13 further comprising feedback means that processes the filtered matrices recursively until two consecutive processed matrices are substantially identical.

16. The apparatus of claim 15 further comprising a noise filter that removes noise.

17. The apparatus of claim 15 further comprising a boundary extractor that extracts image boundaries from the processed matrices.

18. A software product for processing image matrices comprising conversion means for converting said image matrices into cooccurrence matrices.

19. The software product of claim 18 wherein said cooccurrence matrices are offset temporaly.

20. The software product of claim 18 wherein said cooccurrence matrices are offset spatially,
